(19) United States
(12) Patent Application Publication
(10) Pub. No.: US 2021/0191681 A1
(43) Pub. Date: Jun. 24, 2021

(54) METHOD AND APPARATUS FOR PROVIDING CONTENTS ASSOCIATED WITH SIDEBAR USING USER TERMINAL INCLUDING A PLURALITY OF DISPLAYS

(71) Applicant: NAVER CORPORATION, Seongnam-si (KR)

(72) Inventors: Eunbi JOE, Seongnam-si (KR); Hanno LEE, Seongnam-si (KR); Jinah PARK, Seongnam-si (KR); Jung Hee BAEK, Seongnam-si (KR); Hyoung Jung KIM, Seongnam-si (KR); Yeongje KIM, Seongnam-si (KR); Byungsoo KIM, Seongnam-si (KR); Jihyun HWANG, Seongnam-si (KR)

(21) Appl. No.: 17/115,171

(22) Filed: Dec. 8, 2020

(30) Foreign Application Priority Data
Dec. 9, 2019 (KR) 10-2019-0162611

(51) Int. Cl. G06F 3/14; G06F 3/0481; G06F 3/0484; G06F 3/0488; G06F 40/14

(52) U.S. Cl. CPC G06F 3/1423; G06F 3/0481; G06F 40/14; G06F 3/04883; G06F 3/04842

(57) ABSTRACT

A content providing method includes displaying first content provided through an application executed by a user terminal on a first display of the user terminal having a plurality of displays; and displaying second content associated with a sidebar of the first content on a second display of the user terminal in response to detecting an input from a user on a preset area of the first display.

### CROSS-REFERENCE TO RELATED APPLICATION(S)

This U.S. non-provisional application claims the benefit of priority under 35 U.S.C. § 119 to Korean Patent Application No. 10-2019-0162611 filed on Dec. 9, 2019, in the Korean Intellectual Property Office (KIPO), the entire contents of which are incorporated herein by reference.

### BACKGROUND OF THE INVENTION

### Field of Invention

One or more example embodiments of the following description relate to a method of providing content through a user terminal including a plurality of displays, and more particularly, to a method of displaying first content provided through an application on a single display of a user terminal and displaying content associated with the application or a sidebar for providing a service associated with the first content on another display of the user terminal.

### Description of Related Art

Recently the thickness of a display, for example, a touch panel, used for a user terminal, such as a smartphone, has become thinner, and there is an increasing need for displaying more information on the user terminal. Accordingly, proposed is a user terminal that includes a plurality of displays, such as a smart device that includes a dual display or a foldable smart device.

A user terminal that includes a plurality of displays may display various types of information using the plurality of displays or may provide a function of customizing and thereby using each of the plurality of displays. In the case of appropriately using the plurality of displays to provide, that is, display contents, the plurality of displays may maximize the convenience of a user viewing the contents.

Accordingly, in providing, that is, displaying content, there is a need for a content providing method that may overcome the limitations of a user terminal having only a single display and may appropriately divide content and additional content related to the content based on user convenience and display the divided content.

Korean Patent Laid-Open Publication No. 10-2010-0003089, published on Jan. 7, 2010, describes a web server and a mobile terminal device and method for displaying a webpage on a mobile terminal and a method that may display a webpage at a size desired by a user instead of automatically adjusting the webpage to fit a display screen of the mobile terminal.

The aforementioned information is merely provided to help the understanding of the present invention and may include content that does not form a portion of the related art and may not include content that the related art may provide to those skilled in the art.

### BRIEF SUMMARY OF THE INVENTION

One or more example embodiments provide a content providing method that may display first content provided through an application executed by a user terminal on a first display of the user terminal including a plurality of displays and may display second content associated with a sidebar provided from the application (or a sidebar for providing at least one function or service associated with the application or the first content) on a second display of the user terminal in response to detecting an input from a user on a preset area of the first display.

One or more example embodiments also provide a content providing method that may determine a layout of second content depending on whether another content is displayed on a second display of a user terminal including a plurality of displays and may display the second content on the second display, in the case of displaying content associated with a sidebar provided from an application on the second display of the user terminal including the plurality of displays.

According to an aspect of at least one example embodiment, there is provided a content providing method through a user terminal including at least two displays, the content providing method including displaying first content provided through an application executed by the user terminal on a first display among the displays; and displaying second content associated with a sidebar for providing at least one function or service associated with the application or the first content on at least a portion of an area of a second display among the displays in response to detecting an input from a user on a preset area of the first display.

The application may be a web browser application, the first content may include a webpage provided through the web browser application, and the at least one function or service provided from the sidebar may include at least one of a search function using a search engine, a search function for the webpage, a sharing function for the webpage, a scrap function for the webpage, a bookmark function for the webpage, a translation function for the webpage, a memo function, a media player execution function, and an extended application installation function for the application.

The displaying of the second content associated with the sidebar may include displaying the second content on the at least a portion of the area of the second display in response to detecting a selection from the user on a button provided on the preset area of the first display.

The displaying of the second content associated with the sidebar may include displaying the second content on the at least a portion of the area of the second display provided in a first direction relative to the first display, in response to detecting a drag input from the user in the first direction from the preset area of the first display.

The drag input may be a touch input from the user that extends from the preset area to an edge of the first display in the first direction, a touch input from the user that extends from the preset area to an area within the second display in the first direction, or a touch input that is a combination of a first touch input from the user that extends from the preset area to the edge of the first display and a second touch input from the user that extends from an edge of the second display to the area within the second display, in the first direction.

The displaying of the second content associated with the sidebar may include determining whether another content is displayed on the second display; determining a layout of the second content based on whether the other content is displayed on the second display; and displaying the second content of which the layout is determined on the at least a portion of the area of the second display.

The displaying of the second content associated with the sidebar may include determining the layout of the second content such that a size of the second content is less than a full screen and displaying the second content on the at least a portion of the area of the second display if the other content is displayed on the second display; and determining the layout of the second content such that the second content is displayed in the full screen on the second display and displaying the second content in the full screen on the second display if the other content is not displayed on the second display.

The second content may include a list of a plurality of functions or services provided from the sidebar, and a list of the second content of which the layout is determined such that the size of the second content is less than the full screen and thereby displayed may include a number of functions or a number of services less than the list of the second content of which the layout is determined such that the size of the second content is displayed in the full screen and thereby displayed.

The displaying of the second content associated with the sidebar may include changing the layout of the second content such that the second content has a preset transparency and thereby displaying the second content to overlap the other content if the other content is displayed on the second display.

The displaying of the second content associated with the sidebar may include displaying the second content on the at least a portion of the area of the second display in response to detecting a drag input from the user from the preset area of the first display, determining the layout of the second content such that the second content is displayed on an area of an upper end portion of the second display and displaying the second content on the area of the upper end portion of the second display, if the drag input is a touch input from the user that extends to an area of an upper end portion of an edge of the first display or the area of the upper end portion of the second display, and determining the layout of the second content such that the second content is displayed on an area of a lower end portion of the second display and displaying the second content on the area of the lower end portion of the second display, if the drag input is a touch input from the user that extends to an area of a lower end portion of an edge of the first display or the area of the lower end portion of the second display.

The displaying of the second content associated with the sidebar may include displaying the second content on the at least a portion of the area of the second display in response to detecting a drag input from the user from the preset area of the first display, and determining a layout of the second content such that the second content is displayed in a full screen on the second display and displaying the second content in the full screen on the second display area, if the drag input is a touch input from the user that extends to an area of a middle portion of an edge of the first display or an area of a middle portion of the second display.

The determining of whether the other content is displayed on the second display may include determining whether video content is played as the other content on the second display and, if the video content is determined to be played as the other content, determining the layout of the second content to not interfere with the video content and displaying the second content on the at least a portion of the area of the second display.

When the other content provided through the application is displayed on the second display, a layout of the second content is determined such that the second content is displayed to overlap the other content as a layer separate from the other content and the second content is displayed to overlap the other content on the at least a portion of the area of the second display.

The displaying of the second content associated with the sidebar may include displaying a visual indicator representing that the second content is transitioned from the first display and displayed on the second display in response to detecting the input from the user; and displaying the second content on the at least a portion of the area of the second display in response to the visual indicator being displayed on the second display.

The displaying of the second content associated with the sidebar may include displaying a screen for providing a function or a service corresponding to a preset touch gesture among functions or services provided from the sidebar on the at least a portion of the area of the second display as the second content if the input from the user includes the preset touch gesture.

The displaying of the second content associated with the sidebar may include determining whether the input from the user includes the preset touch gesture; and displaying a list of functions or services provided from the sidebar on the at least a portion of the area of the second display as the second content if the input from the user is determined to not include the preset touch gesture.

According to an aspect of at least one example embodiment, there is provided a user terminal including at least two displays; and at least one processor configured to execute computer-readable instructions. The at least one processor is configured to display first content provided through an application executed by the user terminal on a first display among the displays, and to display second content associated with a sidebar for providing at least one function or service associated with the application or the first content on at least a portion of an area of a second display among the displays in response to detecting an input from a user on a preset area of the first display.

The at least one processor may be further configured to determine whether another content is displayed on the second display, to determine a layout of the second content based on whether the other content is displayed on the second display, and to display the second content of which the layout is determined on the at least a portion of the area of the second display.

The at least one processor may be further configured to determine whether the input from the user includes the preset touch gesture, and to display a list of functions or services provided from the sidebar on the at least a portion of the area of the second display as the second content if the input from the user is determined to not include the preset touch gesture, and to display a screen for providing a function or a service corresponding to a preset touch gesture among functions or services provided from the sidebar on the at least a portion of the area of the second display as the second content if the input from the user includes the preset touch gesture.

According to some example embodiments, in the case of providing content through a user terminal including a plurality of displays, it is possible to provide second content without interfering with first content by displaying the first content provided through an application executed by a user terminal on a first display and by displaying the second content associated with a sidebar provided from the corresponding application on the second display. Accordingly, the user convenience may be enhanced in providing the content through the user terminal.

Also, according to some example embodiments, in the case of displaying content associated with a sidebar provided from an application on a second display, it is possible to determine a layout of second content depending on whether another content is displayed on the second display and to display the second content on the second display to not interfere with other contents displayed on the second display.

Also, according to some example embodiments, it is possible to provide an intuitive user interface for displaying second content corresponding to additional content on a second display that is separate from a first display on which first content provided through the application is displayed.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 illustrates an example of a content providing method through a user terminal including at least two displays according to an example embodiment;

FIG. 2 illustrates an example of a user terminal including at least two displays and a server configured to provide content to the user terminal according to an example embodiment;

FIG. 3 is a flowchart illustrating an example of a content providing method through a user terminal including at least two displays according to an example embodiment;

FIGS. 4 to 6 are flowcharts illustrating examples of a method of displaying second content associated with a sidebar on a second display among displays included in a user terminal according to an example embodiment;

FIG. 7 illustrates an example of a method of displaying second content associated with a sidebar on a second display of a user terminal in response to a drag input on a first display and/or the second display of the user terminal according to an example embodiment;

FIGS. 8A, 8B, 8C, and 8D illustrate examples of a method of displaying second content associated with a sidebar on a second display of a user terminal in response to another content being displayed on the second display according to an example embodiment;

FIG. 9 illustrates an example of a method of displaying second content associated with a sidebar at a different location of a second display of a user terminal in response to a drag input on a first display and/or the second display of the user terminal according to an example embodiment; and

FIG. 10 illustrates an example of a method of displaying second content of a different type on a second display of a user terminal in response to an input of a touch input including a preset gesture on a first display and/or the second display of the user terminal according to an example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

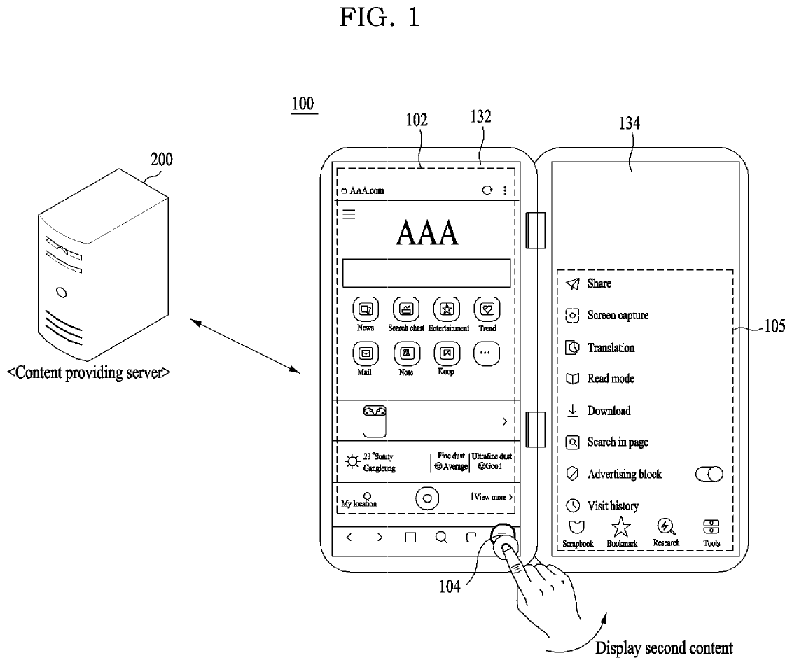

FIG. 1 illustrates an example of a content providing method through a user terminal including at least two displays according to an example embodiment.

A method of displaying first content 102, provided from a content providing server 200 to a user terminal 100 including at least two displays, on a first display 132 of the user terminal 100 and displaying second content 105, corresponding to additional content associated with a sidebar, on a second display 134 of the user terminal 100 is described with reference to FIG. 1

Referring to FIG. 1, the user terminal 100 may refer to a device including at least two displays, such as, for example, a foldable smart device. The first content 102 may be provided to a user through an application executed by the user terminal 100 and displayed on the first display 132. The application executed by the user terminal 100 may be, for example, a web browser application and the first content 102 may be a webpage. Here, the content providing server 200 configured to provide the first content 102 to the user terminal 100 may be a web server.

Referring to FIG. 1, the user terminal 100 may display, on the first display 132, the first content 102 provided from the content providing server 200 through the application corresponding to the web browser application.

The user of the user terminal 100 may display the second content 105 on the second display 134 through interaction on a preset area (e.g., a button) 104 of the first display 132. In response to detecting an input from the user on the preset area 104 of the first display 132, the second content 105 associated with the sidebar of the first content 102 may be displayed on the second display 134. The preset area 104 may be displayed at a lower end of the first display 132. For example, the preset area 104 may be included in a lower end bar of the first display 132 as the button 104 for displaying the sidebar or the second content 105 associated with the sidebar. A sidebar may be initially displayed in the first display 132 or hidden from view. The preset area 104 serves to indicate to the user of the existence of a sidebar when it is hidden from view. When the user sees an object, e.g., a button in the preset area 104, the user may recognize that there is a sidebar. In other words, the user may recognize that the button 104 is designed for displaying the sidebar on the second display 134.

button(s) or an icon(s) corresponding to a function frequently used by the user of the application may be further included in the lower end bar.

The sidebar may be a user interface for providing at least one function or service associated with the application executed by the user terminal 100 or the first content 102 provided through the corresponding application. That is, the user may execute a function, or a service associated with the application or the first content 102 through the sidebar, for example, by selecting the function or the service from the sidebar.

The second content 105 that is content associated with the sidebar may include a list of functions or services associated with the application or the first content 102, that is, a list of functions or services provided from the sidebar.

If the user terminal 100 includes only a single display, for example, the first display 132, the second content 105 may be displayed to overlap the first content 102 on the first display 132 in response to detecting an input from the user on the preset area 104 in a state in which the first content 102 is displayed on the first display 132. In this case, the user may experience interference in reading the first content 102, particularly, may experience inconvenience if the user terminal 100 has a limited size of the first display 132.

According to the example embodiment, the user terminal 100 including at least the first display 132 and the second display 134 may be used and, here, the first content 102 may be displayed on the first display 132 and the second content 105 may be displayed on the second display 134. In this manner, the user may read the first content 102 on the first display 132 without experiencing inconvenience or interference.

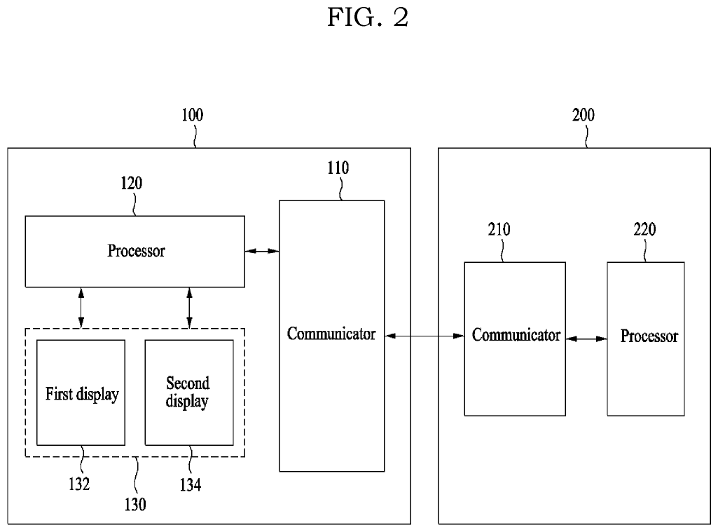

A method of displaying the second content 105, associated with the sidebar of the first content 102, on the second display 134 is further described below with reference to FIGS. 2 to 10.

FIG. 2 illustrates an example of a user terminal including at least two displays and a server configured to provide content to the user terminal according to an example embodiment.

Hereinafter, the content providing server 200 configured to provide the first content 102 to the user terminal 100 and the user terminal 100 configured to display the first content 102 and the second content 105 on the first display 132 and the second display 134 are further described.

The content providing server 200 may be a server configured to provide the first content 102, for example, a webpage to a client, for example, the user terminal 100. The content providing server 200 may provide the first content 102 to the user terminal 100 through communication with an application, for example, a web browser application, installed on the user terminal 100. The content providing server 200 may be configured as at least one computer or computing apparatus.

A communicator 210 may be an apparatus for communication between the content providing server 200 and another server or the user terminal 100. That is, the communicator 210 may be a hardware module, such as a network interface card, a network interface chip, and a networking interface port of the content providing server 200, or a software module, such as a network device driver or a networking program, configured to transmit and receive data and/or information about the other server or the user terminal 100.

A processor 220 may manage components of the content providing server 200, may execute a program or an application used to provide the first content 102 to the user terminal 100, and may process operations required to execute the program or the application and to process data. Also, the processor 220 may be configured to process data received from the other server and the user terminal 100. The processor 220 may be at least one processor of the content providing server 200 or at least one core within the processor.

The user terminal 100 may include a personal computer (PC), a laptop computer, a smartphone, a tablet, a wearable computer, an Internet of things (IoT) device, and the like, and may refer to any type of terminal devices or electronic devices capable of installing and executing an application/program for connection to a web site/mobile site associated with the content providing server 200 or for receiving and reading the first content 102. The user terminal 100 may perform content providing operations, such as displaying the first content 102, data input, data transmission and reception, and data storage under control of the application, such as the web browser application.

The user terminal 100 may correspond to a content providing apparatus in that the user terminal 100 corresponds to an apparatus for providing content to the user.

The user terminal 100 may include a communicator 110, a processor 120, and at least two displays 130. The user terminal 100 may be a foldable terminal that includes at least two displays 130. For example, referring to FIG. 1, the user terminal 100 may be a foldable terminal in which the first display 132 and the second display 134 are provided based on a folding portion, for example, a hinge. The user terminal 100 may be an inwardly and outwardly foldable device. Alternatively, the user terminal 100 may be a foldable terminal that includes a single foldable, for example, flexible display. Here, each of the first display 132 and the second display 134 may represent a partitioned area on a single display.

According to an example embodiment, at least a portion among the components of the user terminal 100 may be physically separable. For example, one of the first display 132 and the second display 134 may be provided to be physically detachable from the other display.

The communicator 110 may refer to an apparatus for communication between the user terminal 100 and the other server or the other user terminal. That is, the communicator 110 may be a hardware module, such as a network interface card, a network interface chip, and a networking interface port of the user terminal 100, or a software module, such as network device driver or a networking program, configured to transmit and receive data and/or information about the other server or the other user terminal. The communicator 110 may receive the first content 102 provided from the content providing server 200.

The processor 120 may manage components of the user terminal 100 and may execute a program or an application used by the user terminal 100. For example, the processor 120 may install and execute an application/program, for example, a web browser application to receive and display the first content 102 provided from the content providing server 200, and may process an operation required to execute the program or the application and to process data. The processor 120 may be at least one processor of the user terminal 100 or at least one core within the processor.

The processor 120 may display the first content 102 provided through the application executed by the user terminal 100 on the first display 132 and, in response to detecting an input from the user on the preset area 104 of the first display 132, may display, on at least a portion of an area of the second display 134, the second content 105 associated with a sidebar provided from the application or a sidebar for providing at least one function or service associated with the application or the first content 102.

Although not illustrated, the user terminal 100 may include a permanent mass storage device, such as random access memory (RAM), a read only memory (ROM), and a disk drive, as a non-transitory computer-readable storage medium. Here, ROM and the permanent mass storage device may be separated from a memory and thereby included in a separate permanent storage device. Also, an OS or at least one program code may be included in the memory. Such software components may be loaded from another non-transitory computer-readable storage medium separate from the memory. The other non-transitory computer-readable storage medium may include a non-transitory computer-readable storage medium, for example, a floppy drive, a disk, a tape, a DVD/CD-ROM drive, a memory card, etc. According to other example embodiments, software components may be loaded to the memory through the communicator 210 instead of, or in addition to, the non-transitory computer-readable storage medium.

The processor 120 may be configured to process computer-readable instructions of a computer program by performing basic arithmetic operations, logic operations, and I/O operations. The computer-readable instructions may be provided from the memory or the communicator 210 to the processor 120. For example, the processor 120 may be configured to execute received instructions in response to the program code stored in the storage device, such as the memory 211, 221. The user terminal 100 may control displaying of the first content 102 and the second content 105 through operation by the processor 120.

Although not illustrated, each of components of the processor 120 for controlling displaying of the first content 102 and the second content 105 may be implemented as a software module and/or hardware module as a part of the processor 120 and may correspond to a function, for example, a functional block, implemented by the processor 120.

The displays 130 may display the first content 102 received from the content providing server 200 and the second content 105 associated with the sidebar. Also, the displays 130 may output data input from the user. Each of the displays 130 may include a touchscreen, for example, a touch panel. Here, each of the displays 130 may be configured to include a function of an inputter (not shown) configured to receive an interaction of the user including a touch input.

The first display 132 and the second display 134 may be the same display. Alternatively, one of the first display 132 and the second display 134 may be a main display and the other one thereof may be a sub display. For example, the first display 132 may be a main display of the user terminal 100 and the second display 134 may be a sub display of the user terminal 100. An execution screen of the application executed by the user terminal 100 may be preferentially displayed on the main display.

The term “display” used herein may represent a screen that represents each of the displays 130 of the user terminal 100.

Description related to technical features made above with reference to FIG. 1 may apply to FIG. 2 and thus, further description related thereto is omitted.

In the following description, an operation performed by components, for example, the processor 120 of the user terminal 100 or an operation performed by the application executed by the user terminal 100 may be described as an operation performed by the user terminal 100 for clarity of description.

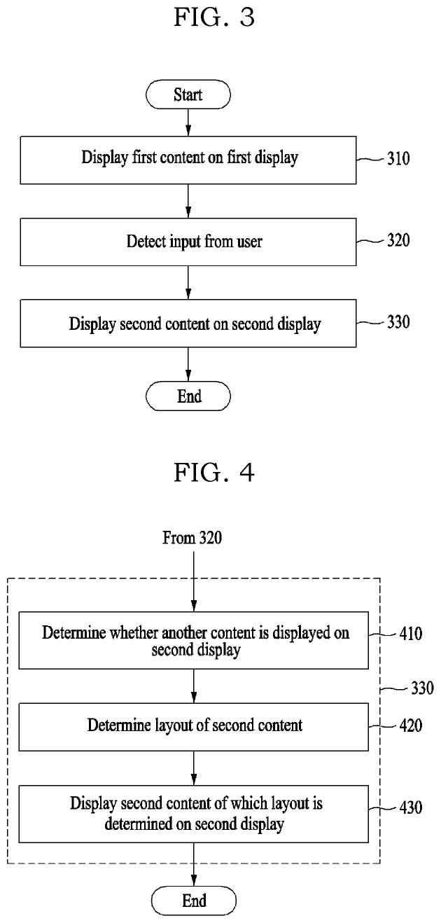

FIG. 3 is a flowchart illustrating an example of a content providing method through a user terminal including at least two displays according to an example embodiment.

Referring to FIG. 3, in operation 310, the user terminal 100 may display, on the first display 132 among the displays 130, the first content 102 provided from the content providing server 200 through an application executed by the user terminal 100. As described above, the application executed by the user terminal 100 may be an application web browser application executed by the user terminal 100 and the first content 102 may include a webpage that is provided through the web browser application. Here, the content providing server 200 may be a web server that provides the first content 102 corresponding to the webpage to the user terminal 100.

In operation 320, the user terminal 100 may detect an input from the user on the preset area 104 of the first display 132. The preset area 104 may refer to an area for displaying of a sidebar of the first content 102 on the first display 132 when the sidebar is initially hidden from view and only the first display 132 is available for operation. The preset area 104 is also used for displaying the second content 105 associated with the sidebar on the second display 134 when the second display is available for operation along with the first display 132. For example, the preset area 104 may be provided as the button 104 of FIG. 1. The input from the user may be a selection or a touch from the user on the button 104. Alternatively, the input from the user may include any interaction, for example, a touch interaction, from the user on the preset area 104.

In operation 330, in response to detecting the input from the user on the preset area 104 of the first display 132, the user terminal 100 may display, on at least a portion of an area of the second display 134, the second content 105 associated with the sidebar (or the sidebar provided from the application) for providing at least one function or service associated with the application or the first content 102. For example, in response to detecting a selection or a touch from the user on a (virtual) button or an icon displayed on the preset area 104 of the first display 132, the user terminal 100 may display the second content 105 on at least a portion of the area of the second display 134.

As described above, the sidebar may be a user interface for providing at least one function or service associated with the application executed by the user terminal 100 or the first content 102 provided through the corresponding application. The at least one function or service provided from the sidebar may include, for example, at least one of a search function using a search engine, a search function for a webpage corresponding to the first content 102, a sharing function for the webpage (e.g., another user or another application), a scrap function for the webpage, a bookmark function for the webpage, a translation function for the webpage, a memo function, a media (music or video) player execution function, and an extended application installation function for the application. The search function may refer to a quick search function and may be a function of providing a user interface capable of inputting a keyword as an execution screen for such a quick search.

Also, the function or the service provided from the sidebar may include a function of displaying the webpage on a window or the second display 134 on which the second content 105 associated with the sidebar is displayed. Also, referring to FIG. 1, the function or the service provided from the sidebar may include a screen capturing function for the webpage corresponding to the first content 102, an advertising blocking function for the webpage, a function of downloading content associated with the webpage, and a function of verifying a webpage visit history.

Also, the function or the service provided from the sidebar may include an additional service, such as a “tool collection service.” The tool collection service may include a service that provides at least one of a clock, a timer, a calculator, a calendar, a unit conversion, and an exchange rate check.

Referring to FIG. 1, the second content 105, that is content associated with the sidebar of the first content 102, displayed on the second display 134 may include a list of functions or services associated with the application or the first content 102, that is, a list of functions or services provided from the sidebar. A function or a service executed in response to a selection on the second content 105 may be displayed on the second display 134.

In operation 330, in response to detecting a drag input from the user in a first direction from the preset area 104 of the first display 132, the user terminal 100 may display the second content 105 on at least a portion of the second display 134 provided in the first direction relative to the first display 132. That is, the second content 105 may be displayed on the second display 134 by considering a direction of the drag input from the user. For example, in response to detecting a drag input from the preset area 104 in a direction different from a direction corresponding to a location at which the second display 134 is provided, the second content 105 may not be displayed on the second display 134.

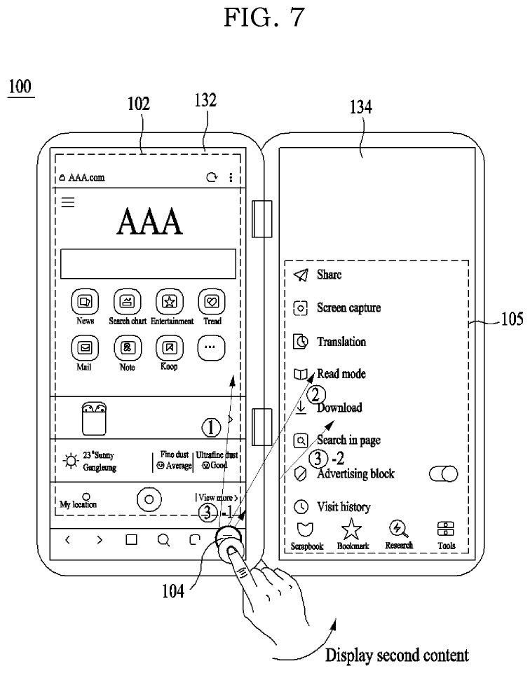

Here, FIG. 7 illustrates an example of a method of displaying the second content 105 associated with the sidebar on the second display 134 in response to a drag input on the first display 132 and/or the second display 134 of the user terminal 100 according to an example embodiment.

Referring to FIG. 7, the drag input for displaying the second content 105 on the second display 134 may be at least one of \textcircled{1}, \textcircled{2}, and \textcircled{3}.

That is, the drag input for displaying the second content 105 on the second display 134 may be a touch input from the user that extends from the preset area 104 to an edge of the first display 132 in a first direction that is a direction corresponding to a location at which the second display 134 is provided (\textcircled{1}). Depending on example embodiments, a touch input that does not necessarily extend to the edge of the first display 132 may still be the drag input for displaying the second content 105 on the second display 134.

Alternatively, the drag input may be a touch input from the user that extends from the preset area 104 to an area within the second display 134 in the first direction (\textcircled{2}).

Alternatively, the drag input may be a touch input corresponding to a combination of a first touch input (\textcircled{3}-1) from the user that extends from the preset area 104 to the edge of the first display 132 and a second touch input (\textcircled{3}-2) from the user that extends from an edge of the second display 134 to the area within the second display 134, in the first direction. Depending on example embodiments, a combination of a touch input (\textcircled{3}-1) that does not necessarily extend to the edge of the first display 132 and a touch input (\textcircled{3}-2) that does not necessarily extend from the edge of the second display 134 to another edge of the second display 134 may be the drag input for displaying the second content 105 on the second display 134. The touch input (\textcircled{3}-2) may need to be input within a desired period of time (e.g., 1 second) after the touch input (\textcircled{3}-1) is input.

Also, according to an example embodiment, the second content 105 associated with the sidebar may be displayed on a different area of the second display 134 based on a direction of the drag input and a location at which the drag input ends.

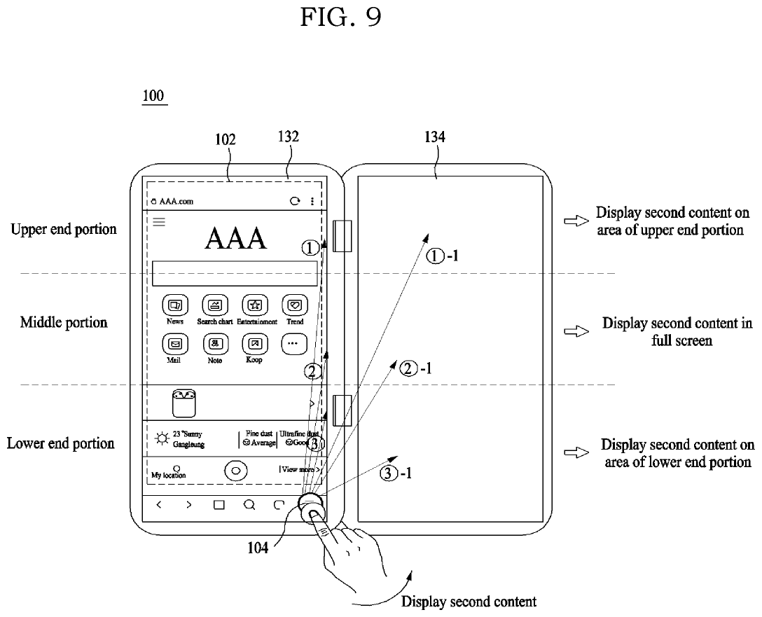

Here, FIG. 9 illustrates an example of a method of displaying the second content 105 associated with the sidebar of the first content 102 on the second display 134 in response to a drag input on the first display 132 and/or the second display 134 of the user terminal 100 according to an example embodiment.

If a drag input from the preset area 104 of the first display 132 is a touch input (\textcircled{1}) from the user that extends to an area of an upper end portion of an edge of the first display 132 (or an area of an upper end portion of the first display 132 not necessarily extending to the edge of the first display 132) or a touch input (\textcircled{1}-1) from the user that extends to an area of an upper end portion of the second display 134, the user terminal 100 may determine a layout of the second content 105 such that the second content 105 may be displayed on the area of the upper end portion of the second display 134 and may display the second content 105 on the area of the upper end portion of the second display 134.

Also, if the drag input from the preset area 104 of the first display 132 is a touch input (\textcircled{3}) from the user that extends to a lower end portion of the edge of the first display 132 (or an area of a lower end portion of the first display 132 not necessarily extending to the edge of the first display 132) or a touch input (\textcircled{3}-1) from the user that extends to an area of a lower end portion of the second display 134, the user terminal 100 may determine the layout of the second content 105 such that the second content 105 may be displayed on the area of the lower end portion of the second display 134 and may display the second content 105 on the area of the lower end portion of the second display 134.

Also, if the drag input from the preset area 104 of the first display 132 is a touch input (\textcircled{2}) from the user that extends to a middle portion of the edge of the first display 132 (or an area of a middle portion of the first display 132 not necessarily extending to the edge of the first display 132) or a touch input (\textcircled{2}-1) from the user that extends to an area of a middle portion of the second display 134, the user terminal 100 may determine the layout of the second content 105 to be displayed such that the second content 105 may be displayed in a full screen on the second display 134 and may display the second content 105 in the full screen on the second display 134.

Here, directions of the touch inputs (\textcircled{1}, \textcircled{1}-1, \textcircled{2}, \textcircled{2}-1, \textcircled{3}, and \textcircled{3}-1) for displaying the second content 105 on the second display 134 are in a direction corresponding to a location at which the second display 134 is provided. Also, the touch inputs (\textcircled{1}-1, \textcircled{2}-1, and \textcircled{3}-1) for displaying the second content 105 on the second display 134 may be combinations of touch inputs for the first display 132 and the second display 134, which is described above with reference to FIG. 7.

According to example embodiments of FIGS. 7 and 9, the user may control a display type of the second content 105 on the second display 134 by controlling the direction of the drag input and the location at which the drag input ends.

As described above, according to example embodiments, it is possible to display the second content 105 on the second display 134 in response to a selection or a touch from the user on the preset area 104 or a drag input on the preset area 104.

Description related to the technical features made above with reference to FIGS. 1 and 2 may apply to FIGS. 3, 7, and 9 and thus, further description related thereto is omitted.

FIGS. 4 to 6 are flowcharts illustrating examples of a method of displaying second content associated with a sidebar on a second display among displays included in a user terminal according to an example embodiment.

FIG. 4 is a flowchart illustrating an example of a method of displaying the second content 105 associated with a sidebar on the second display 134 if another content is displayed on the second display 134 according to an example embodiment.

Referring to FIG. 4, in operation 410, the user terminal 100 may determine whether another content is currently displayed on the second display 134. For example, if a screen of the aforementioned application or another application is displayed on the second display 134 or if a movement of an object(s) displayed on the second display 134 is detected, the user terminal 100 may determine that the other content is displayed on the second display 134. Also, if a home screen or a background screen is displayed on the second display 134, the user terminal 100 may determine that the other content is not displayed on the second display 134.

In operation 420, the user terminal 100 may determine a layout of the second content 105 to be displayed on the second display 134 based on whether the other content is currently displayed on the second display 134. Here, determining the layout may relate to at least one of determining the size of a layer corresponding to the second content 105 to be displayed on the second display 134 and determining the transparency of the layer, for example, changing a transparency parameter for determining the transparency of the layout.

For example, determining the layout of the second content 105 may relate to selecting a single suitable layout option from among a plurality of layout options preset/stored for displaying the second content 105. By applying the selected layout option in displaying the second content 105, the second content 105 may be displayed in the determined layout on the second display 134.

In operation 430, the user terminal 100 may display the second content 105 of which the layout is determined on at least a portion of an area of the second display 134.

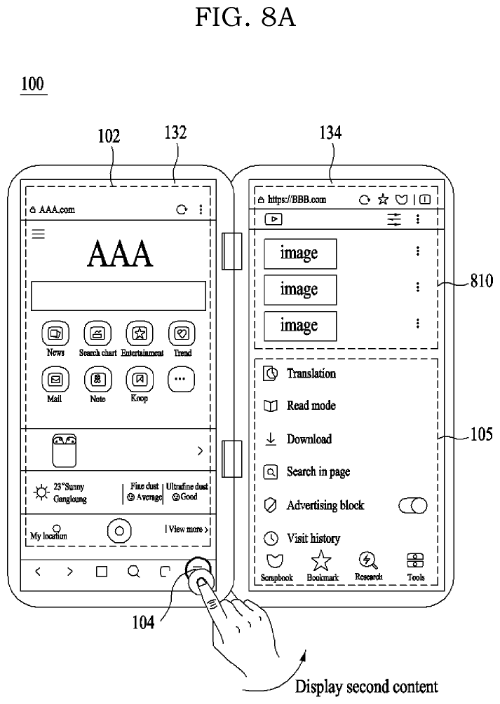

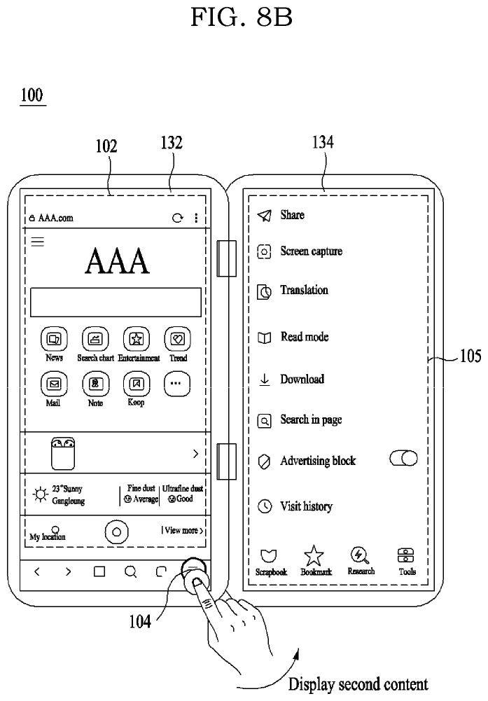

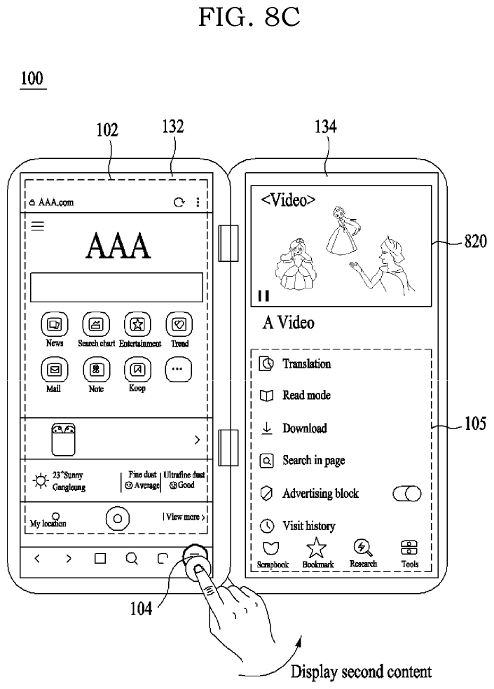

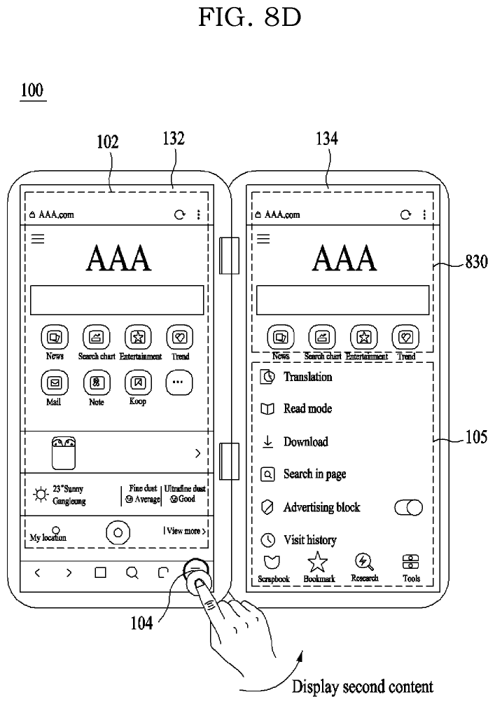

Here, FIGS. 8A, 8B, 8C, and 8D illustrate examples of a method of displaying the second content 105 associated with a sidebar on the second display 134 when another content is currently displayed on the second display 134 of the user terminal 100.

FIG. 8A illustrates an example of displaying the second content 105 associated with a sidebar on the second display 134 when another content 810 is determined to be displayed on the second display 134 of the user terminal 100.

Referring to FIG. 8A, if the other content 810 is determined to be displayed on the second display 134 of the user terminal 100, the user terminal 100 may determine a layout of the second content 105 such that the size of the second content 105 is less than a full screen and may display the second content 105 on at least a portion of an area of the second display 134 without overlapping the other content 810. The second content 105 may also be displayed to overlap the other content 810 and may be displayed on a portion of the second display 134, instead of being displayed in the full screen. Although FIG. 8A illustrates the second content 105 at a lower end of the second display 134, the second content 105 may be displayed at an upper end of the second display 134 depending on example embodiments.

FIG. 8B illustrates an example of displaying the second content 105 associated with a sidebar on the second display 134 when the other content 810 is determined not to be displayed on the second display 134 of the user terminal 100.

Referring to FIG. 8B, if the other content 810 is not displayed on the second display 134, the user terminal 100 may determine a layout of the second content 105 such that the second content 105 may be displayed in the full screen on the second display 134 and may display the second content 105 in the full screen on the second display 134. For example, if a home screen or a background screen is displayed on the second display 134, the user terminal 100 may display the second content 105 in the full screen on the second display 134.

Referring to FIGS. 8A and 8B, the second content 105 displayed on the second display 134 may include a list of a plurality of functions or services associated with an application in execution on the user terminal 100 or the first content 102 provided through the application, that is, a list of functions or services provided through the sidebar.

Here, a list of functions or services included in the second content 105, of which the layout is determined such that the size of the second content 105 is less than the full screen, displayed in FIG. 8A may include a number of functions or services less than that of a list of functions or services included in the second content 105, of which the layout is determined such that the size of the second content 105 is less than the full screen, displayed in FIG. 8B. A list of the second content 105 of FIG. 8A includes five functions or services and a list of the second content 105 of FIG. 8B includes seven functions or services.

Alternatively, a list of the second content 105, of which the layout is determined such that the size of the second content 105 is less than the full screen, may be configured to include only functions or services frequently used by a user of the application. A list of the second content 105, of which the layout is determined to be displayed in the full screen, may be configured to include all of the functions or services.

According to another example embodiment, in displaying the second content 105 associated with the sidebar, if the other content 810 is displayed on the second display 134, the user terminal 100 may change the layout of the second content 105 such that the second content 105 may have a preset transparency (e.g., may be translucent), and may display the second content 105 to overlap the other content 810. For example, the user terminal 100 may change the transparency parameter of the layout for displaying the second content 105. That is, the second content 105 may be configured as a translucence layer and may be displayed to overlap the other content 810. Accordingly, the user may simultaneously identify the other content 810 and the second content 105 that overlaps the other content 810. The transparency may be preset by the user of the application.

Also, according to another example embodiment, referring to FIG. 8C, the user terminal 100 may determine whether video content 820 is being played as the other content in operation 410 of determining whether the other content is displayed on the second display 134.

The user terminal 100 may determine whether the video content 820 is played on the second display 134 as the other content and, if the video content 820 is determined to be played as the other content, may determine the layout of the second content 105 to not interfere with the video content 820 and thereby display the second content 105 on at least a portion of the area of the second display 134.

For example, in response to detecting a movement of object(s) displayed on the second display 134, the user terminal 100 may determine that the video content 820 is displayed on the second display 134. Alternatively, if a media (video) content play application runs on the second display 134 or if a webpage on which the video content is being streamed is displayed on the second display 134, the user terminal 100 may determine that the video content 820 is displayed on the second display 134.

Referring to FIG. 8C, the layout of the second content 105 is arranged so as not to interfere or overlap with the video content 820, and thereby displayed at a lower end of the second display 134. If the video content 820 is displayed at an upper end of the second display 134, the second content 105 may be displayed at a lower end of the second display 134.

Accordingly, the second content 105 may be displayed on the second display 134 without disturbing the user that views the video content 820 through the second display 134.

Also, according to another example embodiment, referring to FIG. 8D, if another content 830 provided through an application, that is, the application through which the first content 102 is provided, is displayed on the second display 134, the user terminal 100 may determine the layout of the second content 105 such that the second content 105 may be displayed to overlap the other content 830 as a layer separate from the other content 830 and may display the second content 105 to overlap the other content 830 on at least a portion of the area of the second display 134, for example, at a lower end of the second display 134.

For example, referring to FIG. 8D, the first content 102 may be provided through the web browser application. If the webpage is displayed as the other content 830 on the second display 134 through the web browser application, the second content 105 may be displayed to overlap the other content 830 as a layer separate from the other content 830. For example, the second content 105 may overlap other content 830 at the lower end of the second display 134. Here, the second content 105 may be displayed with a predetermined transparency.

Accordingly, the second display 134 functions as a sub display for the first display 132. Therefore, although an additional webpage (the other content 830) for the webpage (the first content 102) displayed on the first display 132 (e.g., a webpage that opens as a new window/tab in response to a selection on a link on the webpage displayed on the first display 132) is displayed on the second display 134, the second content 105 associated with the sidebar may be displayed without disturbing the user that views the other content 830.

That is, the aforementioned embodiments related to the method of displaying the second content 105 may apply to not only a case in which different applications run on the first display 132 and the second display 134 but also a case in which the same application runs on the first display 132 and the second display 134.

Meanwhile, if the same application runs on the first display 132 and the second display 134, content, for example, the first content 102, displayed on the first display 132 and content, for example, the other content 830, displayed on the second display 134 may interact with each other. For example, in response to a selection on a specific link, an input of a keyword, or a play request for media content in the content displayed on the first display 132, a result according to the selection of the link, a search result according to the input of the keyword, and playing of the media content according to the play request may be performed on the second display 134.

As described above, according to the example embodiments, although the other content is output on the second display 134, the second content 105 associated with the sidebar may be appropriately displayed on the second display 134.

Description related to the technical features made above with reference to FIGS. 1 to 3 and FIGS. 7 and 9 may apply to FIGS. 4 and 8A to 8D and thus, further description related thereto is omitted.

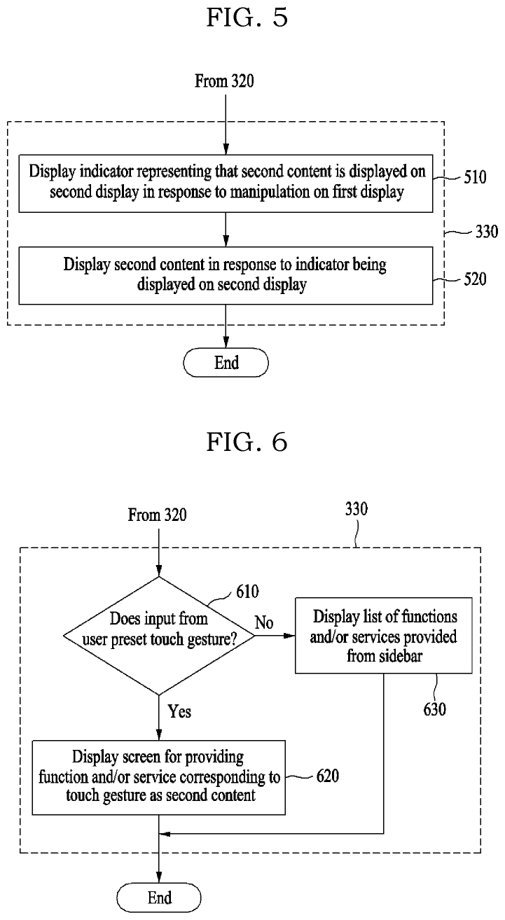

FIG. 5 is a flowchart illustrating an example of a method of outputting an indicator capable of representing that the second content 105 associated with a sidebar is displayed on the second display 134 according to an example embodiment.

Referring to FIG. 5, in operation 510, in response to detecting the input from the user on the preset area 104, the user terminal 100 may display a visual indicator representing that the second content 105 is transitioned from the first display 132 and displayed on the second display 134. Here, the visual indicator may be displayed only on the second display 134 or may be displayed on both the first display 132 and the second display 134. The visual indicator may include an animation effect. Also, the visual indicator may include an image and/or an icon. The visual indicator may include an animation effect representing that the second content 105, to be originally displayed on the first display 132, in response to the input from the user on the preset area 104 is transitioned and displayed on the second display 134.

For example, the visual indicator may include an animation effect showing that an icon or an image representing the second content 105 expands while transitioning from the preset area 104 to an area of the second display 134. For example, the animation effect may represent an effect that displays an icon or an image of the second content 105 (e.g., a thumbnail of the content, an icon of button, etc.). In response to detecting the user's input, the icon or image moves from the preset area 104 to an area of the second display 134 as the size changes. In other words, when the icon or image moves from the preset area 104 to the area of the second display 134, the size of the icon or image gradually increases. Alternatively, the visual indicator may include an animation effect showing that the icon or the image representing the second content 105 expands after transition from the preset area 104 to a center area of the second display 134 and accordingly, is displayed as the second content 105.

Through the visual indicator, the user may visually recognize that the second content 105 is displayed on the second display 134 in response to the input on the preset area 104.

In operation 520, the user terminal 100 may display the second content 105 on the at least a portion of the area of the second display 134 in response to the visual indicator being displayed on the second display 134. When the visual indicator is displayed, that is, once the animation effect included in the visual indicator is executed, the user terminal 100 may display the second content 105 on the second display 134. For example, as described above, in response to the second content 105 expanding after transition from the preset area 104 to the center area of the second display 134, the visual indicator may display the icon or the image representing the second content 105 as the second content 105.

Description related to the technical features made above with reference to FIGS. 1 to 4 and FIGS. 7 to 9 may apply to FIG. 5 and thus, further description related thereto is omitted.

FIG. 6 is a flowchart illustrating an example of a method of controlling displaying of the second content 105 on the second display 134 in response to an input of a preset gesture in displaying the second content 105 associated with a sidebar according to an example embodiment.

Referring to FIG. 6, in operation 610, the user terminal 100 may determine whether the input from the user on the preset area 104 includes a preset touch gesture.

In operation 620, if the input from the user on the preset area 104 is determined to include the preset touch gesture, the user terminal 100 may display a screen for providing a function or a service corresponding to the preset touch gesture among functions or services provided from the sidebar on the at least a portion of the area of the second display 134 as the second content 105. The touch gesture may be preset by a user of an application. The touch gesture may be set for each function or service provided from the sidebar or may be set for each of a predetermined (or, alternatively, desired) number of functions or services frequently used by the user. Since the preset touch gesture is set for a function or a service provided from the sidebar, the corresponding touch gesture may be allocated to the function or the service provided from the sidebar.

In operation 630, if the input from the user on the preset area 104 is determined to not include the preset gesture, the user terminal 100 may display a list of functions or services provided from the sidebar on the at least a portion of the area of the second display 134 as the second content 105.

That is, in response to the input from the user that does not include the preset touch gesture, the user terminal 100 may display a list of functions or services provided from the sidebar corresponding to a built-in screen (an initial screen) of the sidebar on the second display 134 as the second content 105. In response to the input from the user that includes the preset touch gesture, the user terminal 100 may display a screen for providing a function or a service corresponding to the corresponding touch gesture on the second display 134 as the second content 105.

Alternatively, if the input from the user is a one-time click, for example, a touch, on the preset area 104, for example, the button 104, the user terminal 100 may display a list of functions or services provided from the sidebar on the second display 134 as the second content 105. If the input from the user is at least a double click or a double touch on the preset area 104, for example, the button 104, the user terminal 100 may display a screen for providing a function or a service corresponding thereto on the second display 134 as the second content 105.

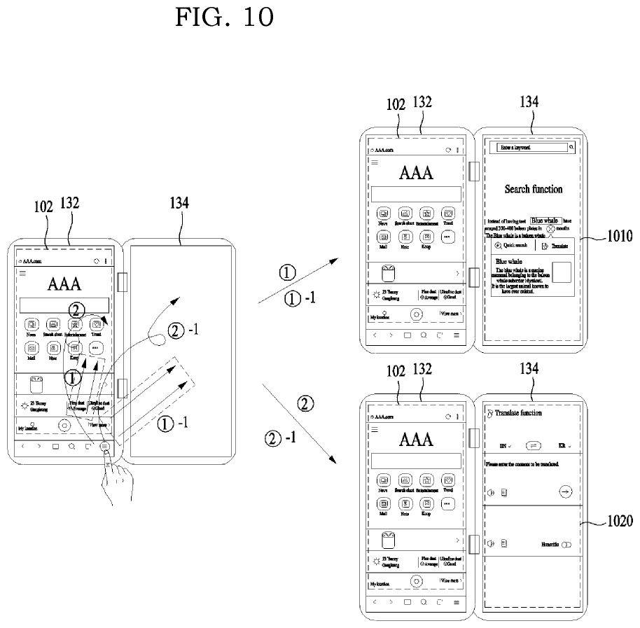

Here, FIG. 10 illustrates an example of a screen for providing a different function or service on the second display 134 as the second content 105 in response to an input of a preset touch gesture.

Referring to FIG. 10, an input from the user on the preset area 104 including a preset touch gesture may be a touch input (\textcircled{1}, \textcircled{1}-1) that uses two or more fingers. In response to the touch input (\textcircled{1}, \textcircled{1}-1), a screen 1010 for providing a “search function” among functions or services provided from the sidebar may be displayed on the second display 134 as the second content 105.

Also, the input from the user on the preset area 104 including the preset touch gesture may be a touch input (\textcircled{2}, \textcircled{2}-1) that include a specific motion, for example, drawing a circle. In response to the touch input (\textcircled{2}, \textcircled{2}-1), a screen 1020 for providing a “translation function” among functions or services provided from the sidebar may be displayed on the second display 134 as the second content 105.

The touch input including the preset touch gesture may be the touch input (\textcircled{1}, \textcircled{2}) on the first display 132, and depending on example embodiments, may be the touch input (\textcircled{1}-1, \textcircled{2}-1) on the first display 132 and the second display 134. That is, in response to the input of the preset touch gesture on the second display 134, the appropriate second content 105 may be displayed on the second display 134.

As described above, the second content 105 displayed on the second display 134 may include a screen for providing a different function or service, that is, a different type of content based on a gesture included in the touch input.

Description related to touch inputs for displaying the second content 105 made above with reference to FIG. 10 may be combined with description related to touch inputs for displaying the second content 105 made above with reference to FIGS. 7 and 9. Further description related thereto is omitted.

Description related to the technical features made above with reference to FIGS. 1 to 8A-8D may apply to FIGS. 9 and 10 and thus, further description is omitted.

The systems and/or apparatuses described herein may be implemented using hardware components such as a processing device, software components, and/or a combination thereof. For example, a processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring a processing device to operate as desired. Software and/or data may be embodied permanently or temporarily in any type of machine, component, physical equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by Appstore that distributes applications or a site, a server, and the like that supplies and distributes other various types of software. Examples of program instructions include both machine code, such as those produced by a compiler, and files containing higher level code that may be executed by the computer using an interpreter. The described hardware devices may act as one or more software modules in order to perform the operations of the above-described embodiments, or vice versa.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A content providing method for a user terminal having at least two displays, comprising:
displaying first content provided through an application executed by the user terminal on a first display of the user terminal; and
displaying second content associated with a sidebar of the first content for providing at least one function or service associated with the application or the first content on at least a portion of an area of a second display of the user terminal in response to detecting an input from a user on a preset area of the first display.

2. The content providing method of claim 1, wherein the application is a web browser application,
the first content includes a webpage provided through the web browser application, and
the at least one function or service provided from the sidebar includes at least one of a search function using a search engine, a search function for the webpage, a sharing function for the webpage, a scrap function for the webpage, a bookmark function for the webpage, a translation function for the webpage, a memo function, a media player execution function, and an extended application installation function for the application.

3. The content providing method of claim 1, wherein the second content associated with the sidebar is displayed on the at least a portion of the area of the second display in response to detecting a selection from the user on a button provided on the preset area of the first display.

4. The content providing method of claim 1, wherein the second content associated with the sidebar is displayed on the at least a portion of the area of the second display provided in a first direction relative to the first display, in response to detecting a drag input from the user in the first direction from the preset area of the first display.

5. The content providing method of claim 4, wherein the drag input is
a touch input from the user that extends from the preset area to an edge of the first display in the first direction,
a touch input from the user that extends from the preset area to an area within the second display in the first direction, or
a touch input that is a combination of a first touch input from the user that extends from the preset area to the edge of the first display and a second touch input from the user that extends from an edge of the second display to the area within the second display, in the first direction.

6. The content providing method of claim 1, wherein the displaying of the second content associated with the sidebar comprises:
determining whether another content is displayed on the second display;
determining a layout of the second content based on whether the other content is displayed on the second display; and
displaying the second content, of which the layout is determined, on the at least a portion of the area of the second display.

7. The content providing method of claim 6, wherein the displaying of the second content associated with the sidebar further comprises:
determining the layout of the second content such that a size of the second content is less than a full screen and displaying the second content on the at least a portion of the area of the second display when the other content is displayed on the second display; and
determining the layout of the second content such that the second content is displayed in the full screen on the second display and displaying the second content in the full screen on the second display when the other content is not displayed on the second display.

8. The content providing method of claim 7, wherein the second content includes a list of a plurality of functions or services provided from the sidebar, and
a list of the second content of which the layout is determined such that the size of the second content is less than the full screen includes a number of functions or a number of services less than the list of the second content of which the layout is determined such that the size of the second content is displayed in the full screen.

9. The content providing method of claim 6, wherein the displaying of the second content associated with the sidebar comprises changing the layout of the second content such that the second content has a preset transparency and thereby displaying the second content to overlap the other content when the other content is displayed on the second display.

10. The content providing method of claim 1, wherein the displaying of the second content associated with the sidebar comprises:
displaying the second content on the at least a portion of the area of the second display in response to detecting a drag input from the user from the preset area of the first display,
determining the layout of the second content such that the second content is displayed on an area of an upper end portion of the second display and displaying the second content on the area of the upper end portion of the second display, when the drag input is a touch input from the user that extends to an area of an upper end portion of an edge of the first display or the area of the upper end portion of the second display, and
determining the layout of the second content such that the second content is displayed on an area of a lower end portion of the second display and displaying the second content on the area of the lower end portion of the second display, when the drag input is a touch input from the user that extends to an area of a lower end portion of an edge of the first display or the area of the lower end portion of the second display.

11. The content providing method of claim 1, wherein the displaying of the second content associated with the sidebar comprises:
displaying the second content on the at least a portion of the area of the second display in response to detecting a drag input from the user from the preset area of the first display, and
determining a layout of the second content such that the second content is displayed in a full screen on the second display and displaying the second content in the full screen on the second display area, when the drag input is a touch input from the user that extends to an area of a middle portion of an edge of the first display or an area of a middle portion of the second display.

12. The content providing method of claim 6, wherein the determining whether the other content is displayed on the second display comprises:
determining whether video content is played as the other content on the second display, and, if the video content is determined to be played as the other content, determining the layout of the second content to not interfere with the video content and displaying the second content on the at least a portion of the area of the second display.

13. The content providing method of claim 6, wherein when the other content is provided through the application and displayed on the second display, a layout of the second content is determined such that the second content is displayed to overlap the other content as a layer separate from the other content and the second content is displayed to overlap the other content on the at least a portion of the area of the second display.

14. The content providing method of claim 1, wherein the displaying of the second content associated with the sidebar comprises:
displaying a visual indicator representing that the second content is transitioned from the first display and displayed on the second display in response to detecting the input from the user; and
displaying the second content on the at least a portion of the area of the second display in response to the visual indicator being displayed on the second display.

15. The content providing method of claim 1, wherein the displaying of the second content associated with the sidebar comprises:
displaying a screen for providing a function or a service corresponding to a preset touch gesture among functions or services provided from the sidebar on the at least a portion of the area of the second display as the second content if the input from the user includes the preset touch gesture.

16. The content providing method of claim 15, wherein the displaying of the second content associated with the sidebar comprises:
determining whether the input from the user includes the preset touch gesture; and
displaying a list of functions or services provided from the sidebar on the at least a portion of the area of the second display as the second content when the input from the user is determined to not include the preset touch gesture.

17. A non-transitory computer-readable recording medium storing instructions that, when executed by a processor, cause the processor to perform the content providing method of claim 1.

18. A user terminal comprising:
at least two displays; and
at least one processor configured to execute computer-readable instructions,
wherein the at least one processor is configured to display first content provided through an application executed by the user terminal on a first display of the user terminal, and to display second content associated with a sidebar of the first content for providing at least one function or service associated with the application or the first content on at least a portion of an area of a second display of the user terminal in response to detecting an input from a user on a preset area of the first display.
